(19) United States
(12) Patent Application Publication
(10) Pub. No.: US 2004/0227354 A1
(43) Pub. Date: Nov. 18, 2004

(54) Door lock assembly for a motor vehicle and method of making same

(76) Inventors: Reinhard Pantke, Bad Liebenzell (DE); Stefan Adams, Leonberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/678,644

(22) Filed: Oct. 6, 2003

(30) Foreign Application Priority Data
Oct. 4, 2002 (DE) 102 46 501.0

(51) Int. Cl. E05C 3/06

(52) U.S. Cl. 292/201

(57) ABSTRACT

A door lock for a motor vehicle has an operable driving element and an output element forming a closure of the door lock. A torque transmitting device connects the driving element with the output element and has a bendable shaft section and drivers each arranged at the ends of the shaft section. One driver is non-rotatably connected with the driving element and the other driver is non-rotatably connected with the output element. For obtaining a cost-effective door lock, the torque transmitting device is constructed in one piece of a plastic material together with its drivers and the flexible shaft section.

### BACKGROUND AND SUMMARY OF THE INVENTION

This application claims the priority of German Application No. 102 46 501.0 filed Oct. 4, 2002, the disclosure of which is expressly incorporated by reference herein.

The invention relates to a door lock for a motor vehicle. Preferred embodiments of the invention relate to a door lock for a motor vehicle, having an operable driving element and an output element forming a closure of the door lock as well as having a torque transmitting device which connects the driving element with the output element and which has a bendable shaft section and drivers each arranged at the ends of the shaft section, one driver being non-rotatably connected with the driving element and the other driver being non-rotatably connected with the output element.

A type-forming door lock is disclosed in German Patent Document DE 196 49 905 A1. It has an operable driving element in the form of a locking cylinder which is connected by way of a torque transmitting device with an output element of the door lock. The output element is the closure which interacts, for example, with a body-side closing bolt. The torque transmitting device comprises a bendable shaft section and drivers provided at its two ends, one driver being non-rotatably connected with the driving element and the other driver being non-rotatably connected with the output element. The torque transmitting device is produced in several parts from a steel cable as the shaft section, to whose ends the drivers, which are made of a plastic material, are injection-molded.

Furthermore, from German Patent Document DE 298 22 913 U1, a torque transmitting device is known which is arranged between a locking cylinder and a closure and which consists of a steel cable as the bendable shaft section and articulated heads fastened to its ends, which are connected with the steel cable by way of cross pins.

It is an object of the invention to provide a door lock of the above-mentioned type which requires lower manufacturing costs.

This object is achieved according to preferred embodiments of the invention by providing a door lock for a motor vehicle, having an operable driving element and an output element forming a closure of the door lock as well as having a torque transmitting device which connects the driving element with the output element and which has a bendable shaft section and drivers each arranged at the ends of the shaft section, one driver being non-rotatably connected with the driving element and the other driver being non-rotatably connected with the output element, wherein the torque transmitting device is constructed in one piece of a plastic material together with its drivers and the flexible shaft section.

Important advantages achieved by means of the invention are that the manufacturing of the torque transmitting device requires no fitting-together since it is made of one piece.

The torque transmitting device, which is preferably produced by injection molding, can therefore be produced in a more cost-effective and simpler manner in one operating step in comparison to prior art torque transmitting devices. With a corresponding material thickness, the plastic material has a certain elasticity, so that the bendable shaft section can be formed, but the plastic material nevertheless has a sufficient stiffness in order to be able to form drivers which, in particular, are form-lockingly connected with the driving and output element respectively.

In order to improve the flexibility of the shaft section or, in the case of a corresponding material thickness, achieve that, according to certain preferred embodiments, the shaft section is equipped with at least one cross-sectional weakening—in the sense of a cross-sectional reduction with respect to the material thickness in the not weakened region of the shaft section—which weakening can be produced during the injection molding of the torque transmitting device or can be provided subsequently in the shaft section by a removal or deformation of the material.

This cross-sectional weakening is implemented as a depression or as a breakthrough in the sense of a removal of material or, as a contraction by a plastic material deformation according to certain preferred embodiments of the invention. The cross-sectional shape and/or the course of the cross-sectional weakening along the shaft section may be arbitrarily selected, in which case attention is paid to low notching or shearing forces at the transitions between the weakened to the unweakened regions.

As a construction alternative for the cross-sectional weakening the shaft section may have a hollow construction at least in sections according to certain preferred embodiments of the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cutout-type view of a motor vehicle door with a door lock having a torque transmitting device between a closure and a locking cylinder, constructed according to a preferred embodiment of the present invention;

FIG. 2a is a side view of a torque transmitting device for the assembly of FIG. 1, constructed according to a preferred embodiment of the invention;

FIG. 2b is a perspective view of the torque transmitting device according to FIG. 2a; and

FIG. 3 is a side view of a torque transmitting device of a door lock constructed according to a second preferred embodiment of the invention.

### DETAILED DESCRIPTION OF THE DRAWINGS

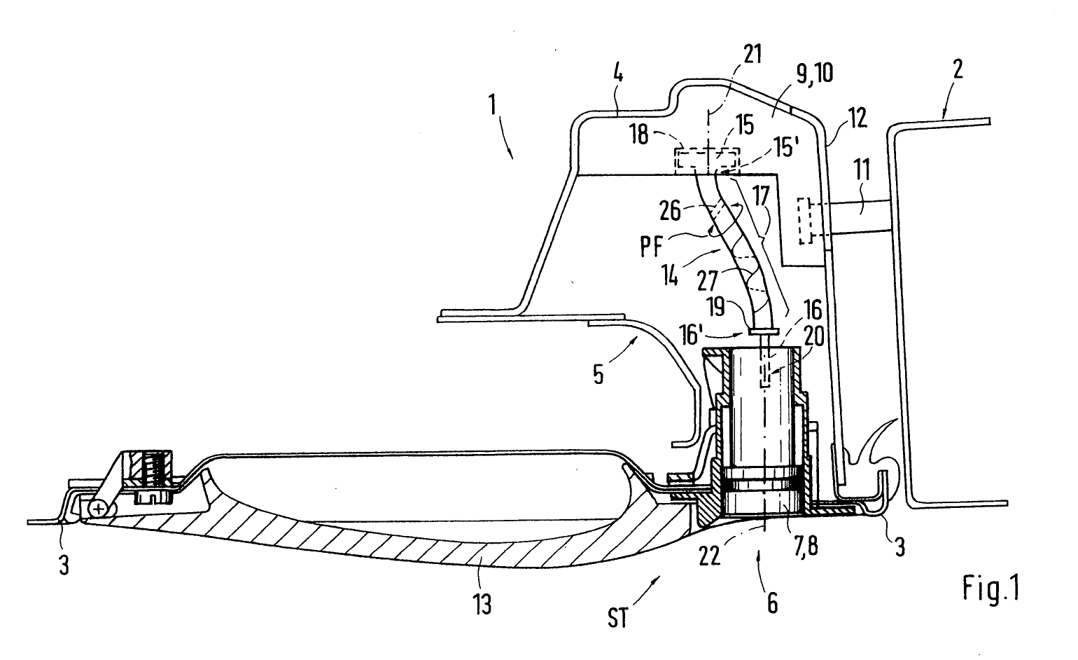

FIG. 1 is a partial sectional view of a door 1 of a motor vehicle, which is otherwise not shown in detail, and a partial sectional view of an upright column, for example, a B-column 2, of the body of the motor vehicle. The door 1 comprises an outer door panel 3 which is connected with a hollow door frame 4, of which an upright frame leg 5 is visible here.

A door lock 6 is inserted into the door 1, which door lock 6 has at least one driving element 7 which can be operated from the outside, particularly in the form of a locking cylinder 8, and an output element 9 which can be controlled by way of the driving element 7, which output element 9 is implemented as a closure 10 which interacts, for example, with a locking element, preferably a locking bolt 11, which is fastened to the B-column 2, in order to hold the door 1 in the closing position ST taken up in FIG. 1 and possibly lock the door there. The locking bolt 11 reaches through a cutout 12 in the frame leg 5 into the closure 10 which is equipped with a locking bar which is not shown here and which is applied to the locking bolt 11. A handle 13 may also be assigned to the door lock 6, which handle 13 may act upon the closure in order to disengage its locking bar from the locking bolt 11, so that the door 1 can be opened.

In addition to the driving element 7 and the output element 9 controlled by the latter, the door lock 6 comprises a torque transmitting device 14 which connects the driving element 7 with the output element 9 situated at an axial distance therefrom, for the purpose of a torque transmission (arrow PF). The torque transmitting device 14 is therefore non-rotatably connected with the driving element as well as with the output element 7 and 9. For this purpose, two drivers 15 and 16 are formed on the torque transmitting device 14 and are mutually connected by way of a flexible shaft section 17 situated in-between.

The driver 15 engages in a form-locking manner in a rotatably coupling member 18 at the closure 10, which coupling member 8 is used for operating the closure 10. In contrast, the driver 16 form-lockingly engages in the rotatable part in the locking cylinder 8. A stop 19 constructed as a surrounding ring collar may also be assigned to the driver 16, which stop 19 is formed in the transition area to the shaft section 14. According to another development of the coupling member 18 and of the locking cylinder 8, the disk-shaped driver 15 may interact with the locking cylinder 8 and the driver 16 having the shape of a paddle 20 may interact with the closure 10. The paddle shape causes a displaceability in the axial direction of the driver and, as a result of the flexible shaft section 17, the offset between the axis of rotation 21 of the coupling member 18 and of the axis of rotation 22 of the locking cylinder 8 can be compensated, in which case, the offset—as illustrated—of the two axes 21 and 22 may be present in parallel at a distance with respect to one another and/or at an angle.

The torque transmitting device 14 with its two drivers 15 and 16 as well as the flexible shaft section 17 and optionally the stop 19 is produced in one piece as a plastic part, for example, by injection molding. Optionally, a fiber-reinforced plastic material may also be used which is essentially inelastic, so that the drivers 15 and 16 arranged at the ends 15′ and 16′ of the shaft section 17 are sufficiently dimensionally stable, so that they are not or only slightly deformed during a torque transmission. In this case, the cross-section of the shaft section may be smaller than the cross-section of the drivers 15 and 16.

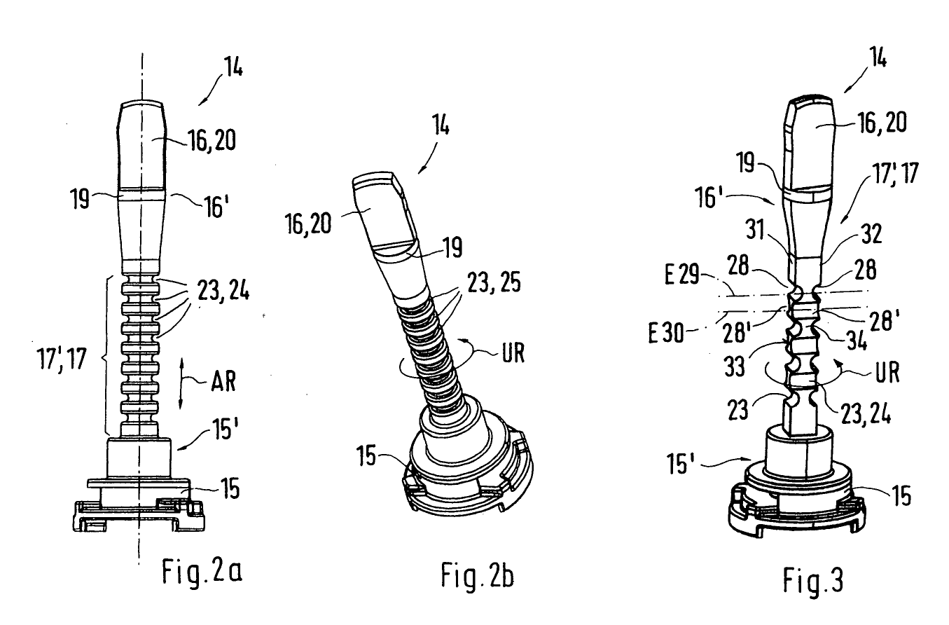

A torque transmitting device 14 according to a first embodiment is illustrated in FIGS. 2a and 2b, FIG. 2b being a perspective view of the torque transmitting device 14 visible in the lateral view in FIG. 2a. Identical and/or identically acting parts as in FIG. 1 are provided with the same reference numbers. One or several cross-sectional weakenings 23 are constructed in the rod-shaped section 17′ of the flexible shaft section 17 which has a circular cross-section, which cross-sectional weakenings 23 are preferably implemented as depressions 24 or constrictions, which may extend completely around the shaft section 17 in the circumferential direction UR, so that ring grooves 25 or ring-shaped constrictions may be formed. Several cross-sectional weakenings 23 may be situated behind one another in the axial direction AR of section 17. FIG. 1 indicates for another embodiment that at least one breakthrough 26 may be present as a cross-sectional weakening 23, which breakthrough 26 transversely penetrates the shaft section 17 or extends in the axial direction, so that the shaft section 17 would be hollow at least in sections. Also, a depression 24 or constriction which follows a helical line 27 may be present in the shaft section, as also indicated in FIG. 1 as another embodiment. In this case, the depression 24 or constriction may follow the helical line 27 without interruptions or may be offset.

As illustrated in FIG. 3, the cross-sectional weakening 23 or depression 24 in the case of a torque transmitting device 14 according to another embodiment may be interrupted, thus limited or offset, in the circumferential direction UR, so that several radial grooves 28 are situated behind one another—viewed in the circumferential direction UR—. Several radial grooves 28 in a plane E29 are offset in the circumferential direction UR with respect to several radial grooves 28′ in a second plane E30 extending parallel to the plane E29. In other words: Radial grooves 28 which—viewed in the axial direction AR—are situated at a distance from additional radial grooves 28′ and are, in addition, offset in the circumferential direction UR with respect to these radial grooves 28′. Thus, in the case of the shaft section 17 with a cornered, particularly four-cornered cross-section, the radial grooves 28 are provided in the opposite flanks 31 and 32 of the rod-shaped section 17′, and the radial grooves 28′ are formed in the opposite flanks 33 and 34. The radial grooves 28 therefore have a distance with respect to the radial grooves 28′ in the axial direction AR. The radial grooves 28 and 28′ as well as the annular grooves 25 in FIG. 2, thus the depressions 24, have a cross-section such that the latter may, in particular, be U-shaped. The at least one breakthrough 26 is arranged in the shaft section 17 such that no or only very low notching or shearing forces occur in the shaft section 17 in the transitions from the recessed (weakened or cross-sectionally reduced) regions 23 to the unweakened regions without any cross-sectional weakening 23. Furthermore, in FIG. 3, identical and/or identically acting parts as in FIGS. 1 and 2 have the same reference numbers.

The torque transmitting device 14 according to FIG. 2, as an alternative preferred embodiment, may have a cornered cross-section of the shaft section 17 which is described in connection with the embodiment according to FIG. 3. The torque transmitting device 14 of FIG. 3 may therefore also have the circular cross-section of the shaft section 17 which is explained in reference to FIG. 2. Finally, the different described cross-sectional shapes of the shaft section 17 may be combined with all indicated cross-sectional weakenings 23.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Door lock for a motor vehicle, having an operable driving element and an output element forming a closure of the door lock as well as having a torque transmitting device which connects the driving element with the output element and which has a bendable shaft section and drivers each arranged at the ends of the shaft section, one driver being non-rotatably connected with the driving element and the other driver being non-rotatably connected with the output element,
wherein the torque transmitting device is constructed in one piece of a plastic material together with its drivers and the flexible shaft section.

2. Door lock according to claim 1, wherein the cross-section of the shaft section is circular.

3. Door lock according to claim 1, wherein the cross-section of the shaft section is four-cornered.

4. Door lock according to claim 1, wherein the shaft section has at least one cross-sectional weakening.

5. Door lock according to claim 1, wherein the plastic material for the torque transmitting device is essentially inelastic.

6. Door lock according to claim 4, wherein the cross-sectional weakening is constructed as a depression in the shaft section which extends in a circumferential direction (UR).

7. Door lock according to claim 4, wherein several cross-sectional weakenings are situated behind one another as viewed in an axial direction (AR) of the torque transmitting device.

8. Door lock according to claim 6, wherein wherein several cross-sectional weakenings are situated behind one another as viewed in an axial direction (AR) of the torque transmitting device.

9. Door lock according to claim 4, wherein the cross-sectional weakening follows a helical line without interruptions or in an offset manner.

10. Door lock according to claim 6, wherein the cross-sectional weakening follows a helical line without interruptions or in an offset manner.

11. Door lock according to claim 7, wherein the cross-sectional weakening follows a helical line without interruptions or in an offset manner.

12. Door lock according to claim 4, wherein the cross-sectional weakening is constructed as a groove, particularly an annular groove or a radial groove, or as a constriction.

13. Door lock according to claim 6, wherein the cross-sectional weakening is constructed as a groove, particularly an annular groove or a radial groove, or as a constriction.

14. Door lock according to claim 7, wherein the cross-sectional weakening is constructed as a groove, particularly an annular groove or a radial groove, or as a constriction.

15. Door lock according to claim 9, wherein the cross-sectional weakening is constructed as a groove, particularly an annular groove or a radial groove, or as a constriction.

16. Door lock according to claim 4, wherein the cross-sectional weakening is implemented as a breakthrough in the shaft section.

17. Door lock according to claim 16, wherein the shaft section is hollow, at least in sections.

18. Door lock according to claim 6, wherein the depression is constructed as at least one radial groove which extends around in a circumferential direction (UR) but is bounded, and
wherein another radial groove is situated at a distance therefrom as viewed in the circumferential direction (UR).

19. Door lock according to claim 12, wherein the depression is constructed as at least one radial groove which extends around in a circumferential direction (UR) but is bounded, and
wherein another radial groove is situated at a distance therefrom as viewed in the circumferential direction (UR).

20. Door lock according to claim 18, wherein several radial grooves bounded in the circumferential direction (UR) are situated behind one another in a spaced manner as viewed in the axial direction (AR).

21. Door lock according to claim 20, wherein several radial grooves situated at a mutual axial distance are offset with respect to one another in the circumferential direction (UR).

22. A torque transmitting device for a motor vehicle door lock of the type having a driving element and an output element, said torque transmitting device including:
a bendable shaft section,
a first driver at a first end of the shaft section which in use is non-rotatably connected with the driving element,
a second driver at a second end of the shaft section which in use is non-rotatably connected with the output element, and
wherein the torque transmitting device including the shaft section and the first and second drivers is formed in one piece of plastic material.

23. A torque transmitting device according to claim 22, wherein said bendable shaft section has at least one cross-sectional weakening along its length.

24. Door lock according to claim 23, wherein the cross-sectional weakening is constructed as a depression in the shaft section which extends in a circumferential direction (UR).

25. Door lock according to claim 24, wherein several cross-sectional weakenings are situated behind one another as viewed in an axial direction (AR) of the torque transmitting device.

26. Door lock according to claim 24, wherein the cross-sectional weakening follows a helical line without interruptions or in an offset manner.

27. Door lock according to claim 24, wherein the cross-sectional weakening is constructed as a groove, particularly an annular groove or a radial groove, or as a constriction.

28. Door lock according to claim 24, wherein the cross-sectional weakening is implemented as a breakthrough in the shaft section.

29. A method of making the torque transmitting device according to claim 22, said method comprising injection molding the torque transmitting device.
